(19) United States
(12) Patent Application Publication
(10) Pub. No.: US 2020/0034356 A1
(43) Pub. Date: Jan. 30, 2020

(54) METHOD, APPARATUS, DEVICE AND STORAGE MEDIUM FOR IMPLEMENTING APPLICATION BASED ON BLOCKCHAIN NETWORK

(71) Applicant: Baidu Online Network Technology (Beijing) Co., Ltd., Beijing (CN)

(72) Inventor: Ya'nan YU, Beijing (CN)

(21) Appl. No.: 16/508,554

(22) Filed: Jul. 11, 2019

(30) Foreign Application Priority Data
Jul. 26, 2018 (CN) 201810837635.5

(51) Int. Cl. G06F 16/23; G06F 16/24; H04L 9/30; H04L 9/06

(52) U.S. Cl. CPC G06F 16/2379; G06F 16/24; H04L 2209/38; H04L 9/0637; H04L 9/3073

(57) ABSTRACT

A method, an apparatus, a device and a storage medium for implementing an application based on a blockchain network are provided. The method includes: interacting a basic operation with a user via a blockchain platform access interface carried by a locally configured lightweight node; interacting data of the basic operation with a basic chain node in the blockchain network through data of a basic chain deployed in the lightweight node; interacting an application operation with the user through a locally installed application client; and interacting data of the application operation with a node of an application parallel chain corresponding to the application through data of the application parallel chain deployed in the lightweight node.

### CROSS-REFERENCE TO RELATED APPLICATIONS

This application claims priority to Chinese Patent Application No. 201810837635.5, filed on Jul. 26, 2018, titled “Method, Apparatus, Device and Storage medium for Implementing Application based on Blockchain Network,” which is hereby incorporated by reference in its entirety.

### TECHNICAL FIELD

Embodiments of the present disclosure relate to the blockchain data processing technique, and specifically to a method, apparatus, device and storage medium for implementing an application based on a blockchain network.

### BACKGROUND

With the rapid development of the blockchain technology, the blockchain technology has become another emerging technology after cloud computing, Internet of things, and artificial intelligence, and has attracted extensive attention due to its technological advantages, such as decentralization, security, and tamper proofing. However, due to the complex underlying technology and lack of industrial standard of the blockchain, development of the blockchain technology has been constrained.

In the existing technology, the blockchain operating system, i.e., the blockchain platform, basically can only provide a single function of browsing and viewing the blockchain assets and information. For an application that achieves its functions based on a blockchain network, only the developer or operator can browse information in underlying blockchain. Only a small part of information associated with digital assets is available for usage by general users of the application. In addition, because applications in the existing blockchain platform are independent from each other, it is impossible to provide a user with alternative applications based on the user demand, to achieve effective promotion of the applications and form a linkage.

### SUMMARY

Embodiments of the present disclosure provide a method, apparatus, device and storage medium for implementing an application based on a blockchain network, to achieve distribution, promotion and management of the application, whilst enabling a user to acquire bottom-layer blockchain information of the installed application.

In a first aspect, embodiments of the present disclosure provide a method for implementing an application based on a blockchain network, applied to a terminal device. The method includes:

interacting a basic operation with a user via a blockchain platform access interface carried by a lightweight node locally configured in a terminal device;

interacting data of the basic operation with a basic chain node in the blockchain network through data of a basic chain deployed in the lightweight node;

interacting an application operation with the user through an application client locally installed in the terminal device; and

interacting data of the application operation with a node of an application parallel chain corresponding to the application through data of the application parallel chain deployed in the lightweight node.

In a second aspect, embodiments of the present disclosure further provide a method for implementing an application based on a blockchain network, applied to a blockchain node. The method includes the following steps:

acquiring a basic chain event request sent by a lightweight node, and processing the basic chain event request, where the basic chain event request includes data of interacting a basic operation with a user via a blockchain platform access interface carried by the lightweight node locally configured in a terminal device; and

acquiring a parallel chain event request sent by the lightweight node, and processing the parallel chain event request, where the parallel chain event request includes data of interacting an application operation with the user via an application client carried by the lightweight node locally configured in the terminal device.

The blockchain node is deployed with both deployment data of the basic chain and deployment data of at least one application parallel chain.

In a third aspect, embodiments of the present disclosure further provide an apparatus for implementing an application based on a blockchain network, configured in a terminal device. The terminal device is locally provided with a lightweight node. The terminal device is provided with the application implemented based on the blockchain network. The apparatus includes:

a basic operation interacting module, configured to interact a basic operation with a user;

a basic chain node interacting module, configured to interact data of the basic operation with a basic chain node in the blockchain network through data of a basic chain deployed in the lightweight node;

an application operation interacting module, configured to interact an application operation with the user; and

a parallel chain node interacting module, configured to interact data of the application operation with a node of an application parallel chain corresponding to the application through data of the application parallel chain deployed in the lightweight node.

In a fourth aspect, embodiments of the present disclosure further provide an apparatus for implementing an application based on a blockchain network, configured in a blockchain node. The apparatus includes the following modules:

a basic chain event request processing module, configured to acquire a basic chain event request a sent by a lightweight node, and process the basic chain event request, where the basic chain event request includes data of interacting a basic operation with a user via a blockchain platform access interface carried by the lightweight node locally configured in a terminal device; and

a parallel chain event request processing module, configured to acquire a parallel chain event request sent by the lightweight node, and process the parallel chain event request, where the parallel chain event request includes data of interacting an application operation with the user via an application client carried by the lightweight node locally configured in the terminal device.

The blockchain node is deployed with both deployment data of the basic chain and deployment data of at least one application parallel chain.

In a fifth aspect, embodiments of the present disclosure further provide a terminal device. The terminal device includes:

one or more processors; and

a memory, configured to store one or more programs;

where the one or more programs, when executed by the one or more processors, cause the one or more processors to implement the method for implementing an application based on a blockchain network as provided in the embodiment of the first aspect.

In a sixth aspect, embodiments of the present disclosure further provide an electronic device. The electronic device includes:

one or more processors; and

a memory, configured to store one or more programs;

where the one or more programs, when executed by the one or more processors, cause the one or more processors to implement the method for implementing an application based on a blockchain network as provided in the embodiment of the second aspect.

In a seventh aspect, embodiments of the present disclosure further provide a computer readable storage medium, storing a computer program thereon, where the program, when executed by a processor, implements the method for implementing an application based on a blockchain network as provided in the embodiments of the first aspect.

In an eighth aspect, embodiments of the present disclosure further provide a computer readable storage medium, storing a computer program thereon, where the program, when executed by a processor, implements the method for implementing an application based on a blockchain network as provided in the embodiments of the second aspect.

According to the embodiments of the present disclosure a basic operation is interacted with a user via a blockchain platform access interface carried by a lightweight node locally configured in a terminal device; data of the basic operation is interacted with a basic chain node in the blockchain network through data of a basic chain deployed in the lightweight node; an application operation is interacted with the user through an application client locally installed in the terminal device; and data of the application operation is interacted with a node of an application parallel chain corresponding to the application through data of the application parallel chain deployed in the lightweight node. The above technical solutions implement a blockchain platform based on a lightweight node architecture of an application and a supernetwork technology, to directly provide a user with application services through the blockchain platform, and achieve distribution, promotion and management of applications, whilst enabling the user to acquire bottom-layer blockchain information of the installed application.

### BRIEF DESCRIPTION OF THE DRAWINGS

FIG. 1 is a flowchart of a method for implementing an application based on a blockchain network in Embodiment I of the present disclosure;

FIG. 2a is a flowchart of a method for implementing an application based on a blockchain network in Embodiment II of the present disclosure;

FIG. 2b is a schematic diagram of an applicable blockchain platform access interface in Embodiment II of the present disclosure;

FIG. 2c is a schematic diagram of an applicable parallel chain information interface in Embodiment II of the present disclosure;

FIG. 3a is a flowchart of a method for implementing an application based on a blockchain network in Embodiment III of the present disclosure;

FIG. 3b is a schematic diagram of an applicable account information interface in Embodiment III of the present disclosure;

FIG. 4 is a flowchart of a method for implementing an application based on a blockchain network in Embodiment IV of the present disclosure;

FIG. 5 is a flowchart of a method for implementing an application based on a blockchain network in Embodiment V of the present disclosure;

FIG. 6 is a flowchart of a method for implementing an application based on a blockchain network in Embodiment VI of the present disclosure;

FIG. 7 is a flowchart of a method for implementing an application based on a blockchain network in Embodiment VII of the present disclosure;

FIG. 8 is a flowchart of a method for implementing an application based on a blockchain network in Embodiment VIII of the present disclosure;

FIG. 9 is a flowchart of a method for implementing an application based on a blockchain network in Embodiment IX of the present disclosure;

FIG. 10 is a flowchart of a method for implementing an application based on a blockchain network in Embodiment X of the present disclosure;

FIG. 11 is a structural diagram of an apparatus for implementing an application based on a blockchain network in Embodiment XI of the present disclosure;

FIG. 12 is a structural diagram of an apparatus for implementing an application based on a blockchain network in Embodiment XII of the present disclosure; and

FIG. 13 is a structural diagram of a terminal device provided in Embodiment XIII of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the present disclosure, rather than limiting the present disclosure. In addition, it should be noted that, for the ease of description, only the parts related to the present disclosure, instead of the whole structure, are shown in the accompanying drawings.

The technical solutions of the embodiments of the present disclosure are implemented based on a superchain network, where the superchain network includes a basic chain network and a parallel chain network. In order to clearly introduce the technical solutions of subsequent embodiments, the superchain network technology is first introduced and illustrated.

A basic chain is a blockchain that can be used to establish a link between various independent blockchains. The basic chain can be associated with a corresponding parallel chain to assist in creating the parallel chain, managing the parallel chain, and assisting the parallel chain in data exchange. For example, the basic chain can be used to establish a link between existing mutually independent blockchains, such that data interaction in the blockchains is no longer limited to an independent blockchain, and such that value flow range is no longer limited to an independent blockchain. That is, the basic chain can manage and supervise operation parameters of the whole blockchain network.

The parallel chain is also a blockchain, and is a concept relative to the basic chain. The parallel chain has all attributes of a general blockchain, and may be established, be managed, and exchange data based on the basic chain. The parallel chain may be derived from the basic chain, or may have equivalent status and functions to the basic chain. The parallel chain and the basic chain may assist each other in establishment, management, and data exchange. One or more parallel chains may be provided. And alternatively, parallel chains are independent of each other without mutual influence, or two parallel chains may have a reciprocal relationship of the base chain and parallel train.

In general, the basic chain is established and runs prior to the parallel chain, and has higher credibility and appeal. The value of the basic chain is more accepted. Therefore, a parallel chain node can take advantage of the credibility and appeal of a basic chain node, to draw support from a node that is willing to provide computing power to provide services for the parallel chain node.

When creating the parallel chain, any node can initiate a basic chain event request, including content of a parallel chain genesis block, i.e., deployment data of the parallel chain. The basic chain node processes the event request and records a creation operation of the parallel chain, which is equivalent to notify nodes in the network. The nodes finally accepting and deploying the parallel chain data participate in the parallel chain, and can subsequently process the parallel chain event request.

The basic chain network and the parallel chain network can constitute a superchain network. One or more basic chains may be provided in the superchain network. It should be noted that there is an overlapping relationship between all nodes participating in the basic chain and all nodes participating in the parallel chain. That is, at least a part of nodes participating in the parallel chain and at least a part of nodes participating in the basic chain are same network nodes. In the overlapping network nodes, all data of blockchains in which the nodes participate are deployed, i.e., deployment data of the basic chain are stored, deployment data of the parallel chain are stored, and blocks of the basic chain and the parallel chain are also stored. The so-called deployment data include desired communication mechanism data, consensus mechanism, smart contract, event request script, and other desired data for participating in the blockchain.

Since data of different blockchains are deployed, such a network node can generate event requests of different blockchains, and can also locally query and acquire event data in the different blockchains, to facilitate cross-chain event processing.

The basic chain is used for supporting data storage of a blockchain platform in the superchain network; and the parallel chain is used for supporting data storage of an application running on the blockchain platform. The blockchain platform may be understood as a service platform capable of supporting functions of various applications. The basic chain stores and processes application data, cache data, and the like of various application management platforms. Moreover, the parallel chain stores data of various applications running on the blockchain platform. For example, a parallel chain can store application data, cache data, and the like of an application.

### Embodiment I

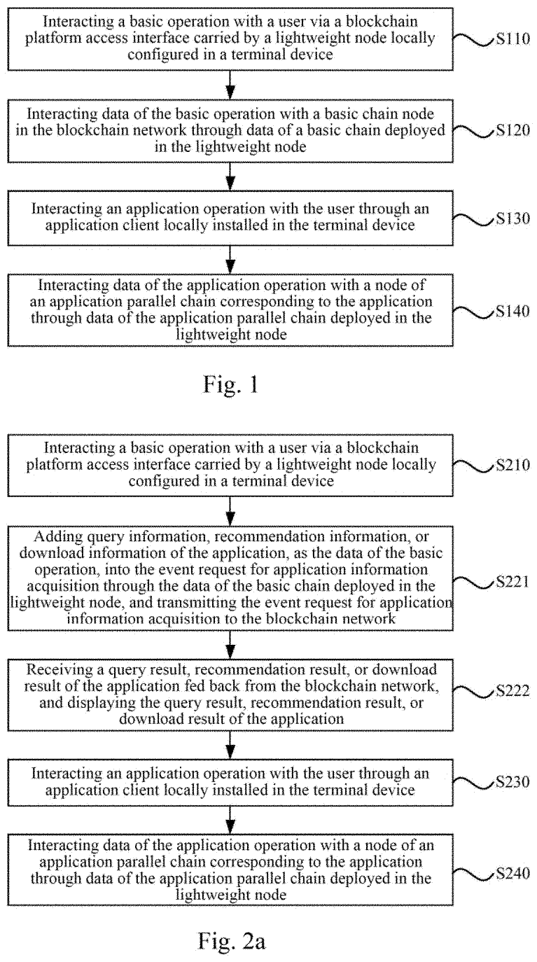

FIG. 1 is a flowchart of a method for implementing an application based on a blockchain network in Embodiment I of the present disclosure. The embodiment of the present disclosure is adapted to implement data interaction between network nodes of a basic chain and/or parallel chain in the blockchain network when an interaction with a user is performed via a blockchain platform access interface carried by a lightweight node, and the interaction with the user is performed through an application client carried by the lightweight node. The present disclosure is executed by an apparatus for implementing an application based on a blockchain network. The apparatus is implemented by software and/or hardware, and is specifically configured in a terminal device that is equipped with a lightweight node and is provided with an application based on the blockchain network. The method for implementing an application based on a blockchain network as shown in FIG. 1 specifically includes the following steps S110 to S140.

S110 includes interacting a basic operation with a user via a blockchain platform access interface carried by a lightweight node locally configured in a terminal device.

The terminal device is locally provided with the lightweight node, and the blockchain platform access interface is carried by the lightweight node, so that the user can interact the basic operation with the terminal device via the blockchain platform access interface. The so-called lightweight node is a node that is deployed with blockchain deployment data, but stores a part of blockchain data. With the operation of the blockchain network, there are more and more blocks, and the requirements for storage space are increasingly higher. A user terminal device is generally difficult to provide such hardware capabilities. Therefore, the concept of lightweight node is proposed. The lightweight node can participate in an event request interaction process of a blockchain, but does not store data of all blocks. When the lightweight node needs to query event data within a block, the lightweight node can acquire the event data from other nodes in real time. The lightweight node may be a plugin integrated in a terminal device operating system.

Specifically, when the user executes a basic operation on the blockchain platform access interface in the terminal device, the terminal device may generate corresponding data based on the basic operation of the user.

Exemplarily, the interacting a basic operation with a user may include at least one of the following items: user account registration, user account login, information query or recommendation of an application issued in the basic chain, application downloading, or management of an element within an account.

S120 includes interacting data of the basic operation with a basic chain node in the blockchain network through data of a basic chain deployed in the lightweight node.

When participating in a superchain network, the lightweight node is deployed with deployment data of the basic chain. Therefore, the lightweight node can interact data with a basic chain node in the blockchain network through the deployment data of the basic chain.

The deployment data may be data corresponding to a data layer, a network layer, a consensus layer, a stimulation layer, a contract layer, and an application layer in the blockchain, e.g., the data such as a data block, a timestamp, a propagation mechanism, an authentication mechanism, an issue mechanism, an algorithm mechanism, a smart contract, or a programmable currency.

Specifically, the terminal device forms a basic chain event request based on data of the basic operation, and transmits the basic chain event request to a basic chain network through the deployment data of the basic chain in the lightweight node. After receiving the basic chain event request, the basic chain node in the basic chain network may process the basic chain event request, generate corresponding event data, store the event data in a block of the basic chain, and provide the generated block to other basic chain nodes in the basic chain network for authentication and storage.

It should be noted that, the basic chain event request may further include data of an application parallel chain, the data of the application parallel chain being used for generating a parallel chain event request, and sending the generated parallel chain event request in a parallel chain network. That is, the basic chain node can know about a need for sending the parallel chain event request to the parallel chain through the basic chain event request, and process the need, to achieve data interaction between the basic chain and the application parallel chain. For example, the basic chain node notifies the application parallel chain about a to-be-processed event, or to-be-queried data, or the like through the parallel chain event request. A block generation node in the parallel chain network can receive the parallel chain event request, process the parallel chain event request to generate parallel chain event data, and stores the parallel chain event data in a block of the parallel chain.

S130 includes interacting an application operation with the user through an application client locally installed in the terminal device.

The lightweight node configured in the terminal device further carries an application client that realizes its own functions based on the blockchain network. The user can further interact an application operation with the terminal device through the application client. The application client is not limited, for example, to various applications having functions such as conventional entertainment, sports, social contact, shopping, and games.

Specifically, when the user executes an application operation at the application client of the terminal device, the terminal device may generate corresponding data based on the application operation of the user.

Exemplarily, the interacting an application operation with the user may include at least one of the following items: an information query operation of the application parallel chain, a transfer operation of a parallel chain element in the application parallel chain, or an exchange operation of the parallel chain element in the application parallel chain.

S140 includes interacting data of the application operation with a node of an application parallel chain corresponding to the application through data of the application parallel chain deployed in the lightweight node.

When downloading and installing the application, the lightweight node is also correspondingly deployed with deployment data of an application parallel chain. Therefore, the lightweight node can interact data with an application parallel chain node in the blockchain network through the deployment data of the application parallel chain.

Specifically, the terminal device forms a parallel chain event request based on data of the application operation, and transmits the parallel chain event request to the parallel chain network through the deployment data of the application parallel chain in the lightweight node. After receiving the parallel chain event request, the application parallel chain node in the parallel chain network may process the parallel chain event request, generate corresponding event data, store the event data in a block of the application parallel chain, and provide the generated block to other application parallel chain nodes in the parallel chain network for authentication and storage.

In the embodiment of the present disclosure, a basic operation is interacted with a user via a blockchain platform access interface carried by a lightweight node locally configured in a terminal device; data of the basic operation is interacted with a basic chain node in the blockchain network through data of a basic chain deployed in the lightweight node; an application operation is interacted with the user through an application client locally installed in the terminal device; and data of the application operation is interacted with a node of an application parallel chain corresponding to the application through data of the application parallel chain deployed in the lightweight node. The above technical solutions implement a blockchain platform based on a lightweight node architecture of an application and supernetwork technology, to directly provide a user with application services through the blockchain platform, and achieve distribution, promotion and management of applications, whilst enabling the user to acquire bottom-layer blockchain information of the installed application.

### Embodiment II

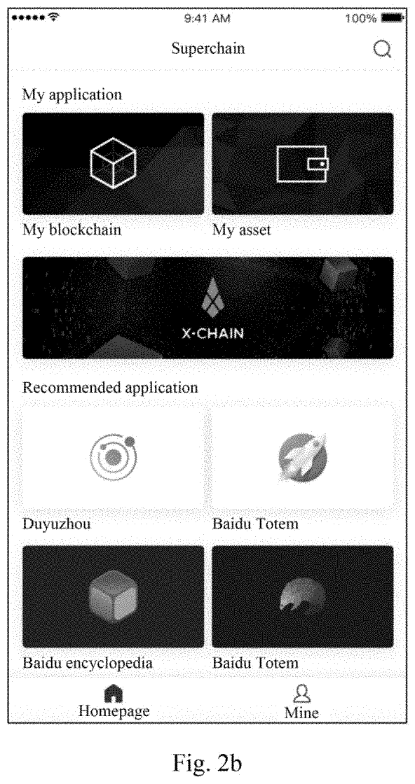

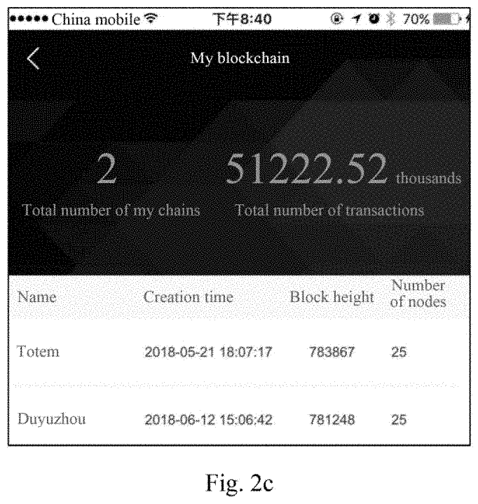

FIG. 2a is a flowchart of a method for implementing an application based on a blockchain network in Embodiment II of the present disclosure. The embodiment of the present disclosure is further specialized and optimized based on the above embodiments.

Further, when the basic operation is information query, recommendation, or downloading of the application, the “interacting data of the basic operation with a basic chain node in the blockchain network through data of a basic chain deployed in the lightweight node” is specified as gadding query information, recommendation information, or download information of the application, as the data of the basic operation, into an event request for application information acquisition through the data of the basic chain deployed in the lightweight node for transmission to the blockchain network, and receiving a query result, recommendation result, or download result of the application fed back from the blockchain network, and displaying the query result, recommendation result, or download result of the application,” to provide the user with application services through the blockchain platform directly based on information query demand, recommendation demand, or download demand of the user, and achieve distribution and promotion of applications.

The method for implementing an application based on a blockchain network as shown in FIG. 2a includes the following steps S210 to S240.

S210 includes interacting a basic operation with a user via a blockchain platform access interface carried by a lightweight node locally configured in a terminal device.

The basic operation is information query, recommendation, or downloading of the application. The recommendation means that the blockchain network platform can recommend some applications to a user based on information of all applications stored in the basic chain. The information inquiry means that a user can actively search for application information in the basic chain. The downloading means that after the user selects the application, the selected application is downloaded and installed through the basic chain. FIG. 2b shows a blockchain platform access interface, which can manage “my blockchain,” and “my assets,” and is also provided with “recommended applications.”

S221 includes adding query information, recommendation information, or download information of the application, as the data of the basic operation, into the event request for application information acquisition through the data of the basic chain deployed in the lightweight node, and transmitting the event request for application information acquisition to the blockchain network.

S222 includes receiving a query result, recommendation result, or download result of the application fed back from the blockchain network, and displaying the query result, recommendation result, or download result of the application.

When the basic operation is an information query operation of the application, the terminal device adds query information, such as a keyword, of the application, as the data of the basic operation, into the event request for application information acquisition through deployment data of the basic chain deployed in the lightweight node, and transmits the event request for application information acquisition in the basic chain network. The information query operation may be querying basic information of an application installed in a terminal device, for example, may be querying name, version, installation time, brief introduction of functions, or the like of the application. The information query operation may alternatively be querying bottom layer information of an application parallel chain corresponding to the installed application, for example, may be querying creation time, block height, parallel chain node information, element information, or the like of the application parallel chain. FIG. 2c shows a queriable display information interface.

After receiving the event request for application information acquisition corresponding to the information query operation, a block generation node in the basic chain network not only processes the event request for application information acquisition, generates corresponding event data, and stores the event data in a block, but also feeds back a corresponding application query result to the lightweight node sending the event request for application information acquisition, and display the application query result via the blockchain platform access interface.

When the basic operation is a recommendation operation of the application, the terminal device adds recommendation information of the application, as the data of the basic operation, into the event request for application acquisition through the deployment data of the basic chain deployed in the lightweight node, and transmits the event request for application information acquisition in the basic chain network. The recommendation information may be a recommendation instruction of a hot list, a friend download list, a weekly hot recommendation list, a latest release, an application classification, or the like.

After receiving the event request for application information acquisition corresponding to the recommendation operation, the block generation node in the basic chain network not only processes the event request for application information acquisition, generates corresponding event data, and stores the event data in a block, but also feeds back a corresponding application recommendation result to the lightweight node sending the event request for application information acquisition, and displays the application recommendation result via the blockchain platform access interface. The recommendation result may be a download link of the application or the application itself; and deployment data of the application parallel chain corresponding to the application.

When the basic operation is a download operation of the application, the terminal device adds download information of the application, as the data of the basic operation, into the event request for application information acquisition through the deployment data of the basic chain deployed in the lightweight node, and transmits the event request for application information acquisition in the basic chain network. The download information may be at least one download instruction of the application, corresponding to a hot list, a friend download list, a weekly hot recommendation list, a latest release, an application classification, or the like.

After receiving the event request for application information acquisition corresponding to the download operation, the block generation node in the basic chain network not only processes the event request for application information acquisition, generates corresponding event data, and stores the event data in a block, but also feeds back a corresponding application download result to the lightweight node sending the event request for application information acquisition, and display the application download result via the blockchain platform access interface. The download result may be a download link of the application or the application itself; and the deployment data of the application parallel chain corresponding to the application.

It should be noted that, whilst the application is downloaded and installed through triggering the download link or the application itself by the user, the deployment data of the application parallel chain corresponding to the application is correspondingly stored. In this case, the lightweight node configured in the terminal device where the application is installed can be used as network nodes of the blockchain network including the application parallel chain corresponding to the application, to interact data with other nodes in the application parallel chain network.

S230 includes interacting an application operation with the user through an application client locally installed in the terminal device.

S240 includes interacting data of the application operation with a node of an application parallel chain corresponding to the application through data of the application parallel chain deployed in the lightweight node.

According to the embodiment of the present disclosure, operations related to interaction between a lightweight node and a basic chain node in the blockchain network are specified, when the basic operation is information query, recommendation, or downloading of an application, to achieve providing a user with application services through the blockchain platform directly based on the query demand, recommendation demand, or download demand of the user, and achieve distribution and promotion of applications.

Based on the technical solutions of the above embodiments, further, when the basic operation is the download operation of the application, before the transmitting the event request for application information acquisition, the method further includes the following steps:

adding data of transferring a basic chain element from a user account to a designated account corresponding to the application into the event request for application information acquisition; where the designated account is an administrator account of the blockchain network or an operator account of the application.

The basic chain element may be a digital currency circulated in the blockchain network for stimulating users. For example, the basic chain element may be a bitcoin, point, stardiamond, energy, or the like. In the basic chain, besides digital currency, other currency unit that can be managed by an account can have a stimulation effect.

The basic chain and the application parallel chain may use same or different types of digital currencies for stimulation. For network nodes of the basic chain and the parallel chain, accounts for storing elements can store various types of digital currencies. The digital currency in each blockchain can interact with the account, such as transferring in or out a digital currency.

The account can be managed by an asymmetric key pair, the public key is an account address, and the private key is saved by an account owner himself.

Specifically, when the basic operation is downloading of the application, the download information of the application, beneficiary account, payer account, to-be-transferred element type and to-be-transferred element amount are added into the event request for application information acquisition through the deployment data of the basic chain deployed in the lightweight node, and the event request for application information acquisition are transmitted in the basic chain network.

After receiving the event request for application information acquisition, the block generation node in the basic chain network not only processes the event request for application information acquisition, generates corresponding event data, and stores the event data in a block, but also transfers a set amount of a to-be-transferred element of a set type from the payer account to the beneficiary account. The set type is a type of the to-be transferred element, and the set amount is only an amount of the to-be-transferred element.

The beneficiary account is the administrator account of the blockchain network or the operator account of the application; the payer account is a user account; the type of the to-be-transferred element is the basic chain element; and the amount of the to-be-transferred element is an amount corresponding the application and preset by the blockchain network administrator or the application operator. Due to high credibility of the basic chain, the value of an element issued by the basic chain can generally be accepted, thereby contributing to promotion of the application.

In the embodiment of the present disclosure, when a user downloads an application based on the blockchain platform, a corresponding event request for application information acquisition carries data of transferring a basic chain element from a user account to a desgnated account corresponding to the application to effect certain payment to an administrator account of the blockchain network or an operator account of the application.

### Embodiment III

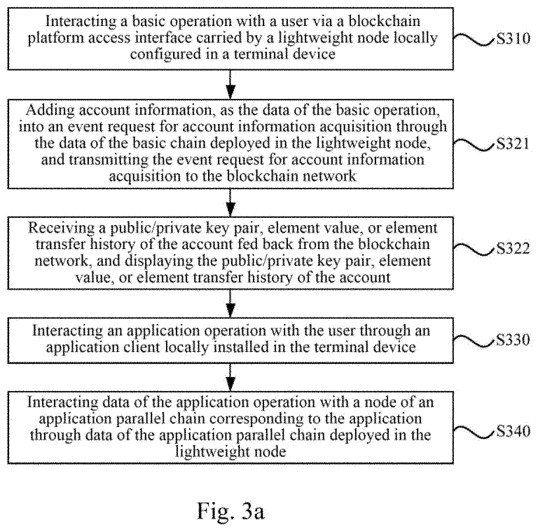

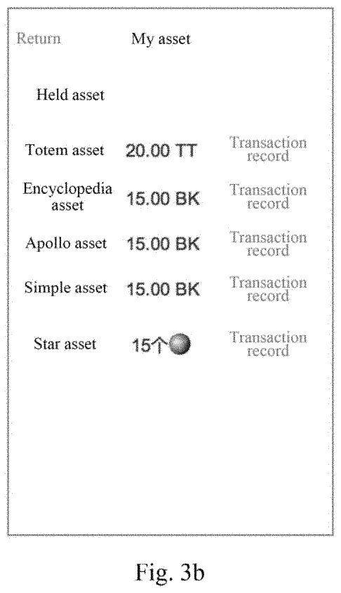

FIG. 3a is a flowchart of a method for implementing an application based on a blockchain network in Embodiment III of the present disclosure. The embodiment of the present disclosure is specified and optimized based on the technical solutions of the above embodiments.

Further, when the basic operation is account registration, account login, or management of an element within an account, the “interacting data of the basic operation with a basic chain node in the blockchain network through data of a basic chain deployed in the lightweight node” is specified as gadding account information, as the data of the basic operation, into an event request for account information acquisition through the data of the basic chain deployed in the lightweight node, and transmitting the event request for account information acquisition to the blockchain network; and receiving a public/private key pair, element value, or element transfer history of the account fed back from the blockchain network, and displaying the public/private key pair, element value, or element transfer history of the account,” to achieve directly providing a user with application services through the blockchain platform, and achieve management of applications.

The method for implementing an application based on a blockchain network as shown in FIG. 3a includes the following steps S310 to S340.

S310 includes: interacting a basic operation with a user via a blockchain platform access interface carried by a lightweight node locally configured in a terminal device.

The basic operation is account registration, account login, or management of an element within an account.

S321 includes adding account information, as the data of the basic operation, into an event request for account information acquisition through the data of the basic chain deployed in the lightweight node, and transmitting the event request for account information acquisition to the blockchain network.

S322 includes receiving a public/private key pair, element value, or element transfer history record of the account fed back from the blockchain network, and displaying the public/private key pair, element value, or element transfer history record of the account.

The account is managed by a public/private key pair, i.e., an asymmetric key pair, the public key is an account address, and the private key is saved by an account owner himself.

When the basic operation is account registration, the terminal device adds pre-registered account information inputted by the user, as the data of the basic operation, into the event request for account information acquisition through deployment data of the basic chain deployed in the lightweight node, and transmits the event request for account information acquisition in the basic chain network. The pre-registered account information may be a request for account registration of the user.

After receiving the event request for pre-registered account information acquisition, a block generation node in the basic chain network not only processes the event request for account information acquisition, generates corresponding event data, and stores the event data in a block, but also feeds back the public/private key pair of the account to the lightweight node sending the event request for account information acquisition, and display the public/private key pair of the account via the blockchain platform access interface.

When the basic operation is account login, the terminal device adds registered account information inputted by the user, as the data of the basic operation, into the event request for account information acquisition through the deployment data of the basic chain deployed in the lightweight node, and transmits the event request for account information acquisition in the basic chain network.

After receiving the event request for registered account information acquisition, the block generation node in the basic chain network only processes the event request for account information acquisition, generates corresponding event data, and stores the event data in a block, but also compares the registered account information with the private key, and permit the user to log in the corresponding account based on the registered account information when the comparison result is successful. The registered account information at least includes the private key saved by the account owner himself.

When the basic operation is management of an element within an account, the terminal device adds the registered account information inputted by the user and account management information, as the data of the basic operation, into the event request for account information acquisition through the deployment data of the basic chain deployed in the lightweight node, and transmits the event request for account information acquisition in the basic chain network. The account management information may be element balance query information of the application, or element transfer history query information of the application, or the like. FIG. 3b shows information display of an element within a user account.

After receiving the event request for registered account information acquisition, the block generation node in the basic chain network not only processes the event request for account information acquisition, generates corresponding event data, and stores the event data in a block, but also feeds back the element value or element transfer history, or the like of the account to the lightweight node sending the event request for account information acquisition, and display the element value or element transfer history, or the like of the account via the blockchain platform access interface.

S330 includes interacting an application operation with the user through an application client locally installed in the terminal device.

S340 includes interacting data of the application operation with a node of an application parallel chain corresponding to the application through data of the application parallel chain deployed in the lightweight node.

The embodiment of the present disclosure specifies operations related to interaction between a lightweight node and a basic chain node in the blockchain network when the basic operation is account registration, account login, or management of an element within an account, to achieve providing a user with application services through the blockchain platform directly based on query demand, recommendation demand, or download demand of the user, and achieve management of applications.

### Embodiment IV

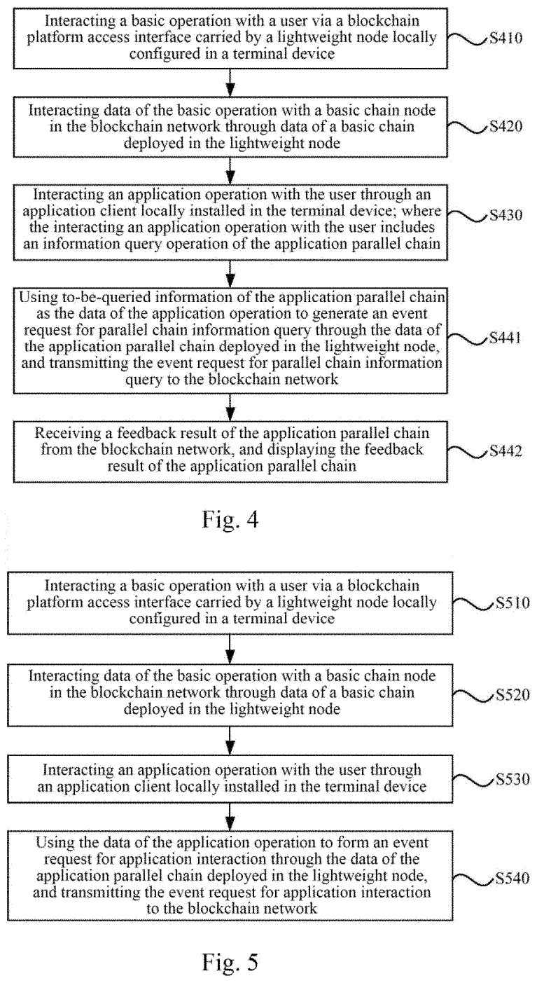

FIG. 4 is a flowchart of a method for implementing an application based on a blockchain network in Embodiment IV of the present disclosure. The embodiment of the present disclosure is specified and optimized based on the technical solutions of the above embodiments.

Further, when the interacting an application operation with the user includes an information query operation of the application parallel chain, the “interacting data of the application operation with a node of an application parallel chain corresponding to the application through data of the application parallel chain deployed in the lightweight node” is specified as the “ using to-be-queried information of the application parallel chain as the data of the application operation to generate an event request for parallel chain information query through the data of the application parallel chain deployed in the lightweight node, and transmitting the event request for parallel chain information query to the blockchain network; and receiving a feedback result of the application parallel chain from the blockchain network, and displaying the feedback result of the application parallel chain; where the feedback result of the application parallel chain includes creation time, block height, parallel chain node information, and element information of the application parallel chain,” enabling the user to acquire bottom layer blockchain information of the installed application.

The method for implementing an application based on a blockchain network as shown in FIG. 4 includes the following steps S410 to S442.

S410 includes interacting a basic operation with a user via a blockchain platform access interface carried by a lightweight node locally configured in a terminal device.

S420 includes interacting data of the basic operation with a basic chain node in the blockchain network through data of a basic chain deployed in the lightweight node.

S430 includes interacting an application operation with the user through an application client locally installed in the terminal device; where the interacting an application operation with the user includes an information query operation of the application parallel chain.

S441 includes using to-be-queried information of the application parallel chain as the data of the application operation to generate an event request for parallel chain information query through the data of the application parallel chain deployed in the lightweight node, and transmitting the event request for parallel chain information query to the blockchain network.

S442 includes receiving a feedback result of the application parallel chain from the blockchain network, and displaying the feedback result of the application parallel chain.

When the user performs an information query operation of the application parallel chain corresponding to the application through an application client, the terminal device uses to-be-queried information of the application parallel chain as the data of the application operation to generate the event request for parallel chain information query through deployment data of the parallel chain deployed in the lightweight node, and transmits the event request for parallel chain information query in a parallel chain network of the application parallel chain. The information query operation of the application parallel chain includes a bottom-layer information query operation of the parallel chain.

After receiving the event request for parallel chain information query, a block generation node in the parallel chain network not only processes the event request for parallel chain information query, generates corresponding event data, and stores the event data in a block, but also sends a corresponding feedback result of the parallel chain to the lightweight node sending the event request for parallel chain information query, and display the feedback result of the parallel chain via the application client interface. The feedback result of the parallel chain includes creation time, block height, parallel chain node information, and element information of the application parallel chain. The parallel chain node information includes a parallel chain node identifier, and the like; and the element information includes a parallel chain element type, and the like. Alternatively, the to-be-queried information may be event data involved in a historical operation process of the application. For example, for a shopping application, a historical transaction record, etc. can be queried.

The embodiment of the present disclosure specifies operations related to interaction between a lightweight node and a parallel chain node in the blockchain network when the interacting an application operation with the user includes an information query operation of the application parallel chain, to enable a user to acquire bottom-layer information of the application parallel chain corresponding to the application installed in the terminal device through the blockchain platform directly based on parallel chain query demand of the user.

### Embodiment V

FIG. 5 is a flowchart of a method for implementing an application based on a blockchain network in Embodiment V of the present disclosure. The embodiment of the present disclosure is further specified and optimized based on the above embodiments.

Further, when the interacting an application operation with the user includes a designated transfer operation of a parallel chain element in the application parallel chain, the “interacting data of the application operation with a node of an application parallel chain corresponding to the application through data of the application parallel chain deployed in the lightweight node” is specified as “using the data of the application operation to form an event request for application interaction through the data of the application parallel chain deployed in the lightweight node, and transmitting the event request for application interaction to the blockchain network, where the event request for application interaction includes data of transferring a parallel chain element from the user account to a designated account corresponding to the application,” to achieve designated transfer of the parallel chain element of the application parallel chain in the user account when the application operation is a transfer operation of the parallel chain element, and facilitate interaction between the user and other users of the application.

The method for implementing an application based on a blockchain network as shown in FIG. 5 includes the following steps S510 to S540.

S510 includes interacting a basic operation with a user via a blockchain platform access interface carried by a lightweight node locally configured in a terminal device.

S520 includes interacting data of the basic operation with a basic chain node in the blockchain network through data of a basic chain deployed in the lightweight node.

S530 includes interacting an application operation with the user through an application client locally installed in the terminal device.

The interacting an application operation with the user includes a designated transfer operation of a parallel chain element in the application parallel chain.

S540 includes using the data of the application operation to form an event request for application interaction through the data of the application parallel chain deployed in the lightweight node, and transmitting the event request for application interaction to the blockchain network.

The event request for application interaction includes data of transferring a parallel chain element from a user account to a designated account corresponding to the application.

When interacting an application operation between an application client and the user includes a transfer operation of the parallel chain element in the application parallel chain, a beneficiary account, a payer account, a to-be-transferred element type and a to-be-transferred element amount are used to form an event request for application interaction through deployment data of the application parallel chain deployed in the lightweight node, and the event request for application interaction is transmitted to the parallel chain network.

After receiving the event request for application interaction, a block generation node in the parallel chain network not only processes the event request for application interaction, generates corresponding event data, and stores the event data in a block, but also transfers a set amount of a to-be-transferred element of a set type from the payer account to the beneficiary account. The set type is a type of the to-be transferred element, and the set amount is only an amount of the to-be-transferred element.

The beneficiary account is the designated account corresponding to the application, for example, may be a friend account of a user account; the payer account is a user account; the to-be-transferred element type is a parallel chain element corresponding to the application; and the to-be-transferred element amount is an amount set by the user himself.

The embodiment of the present disclosure, when the interacting an application operation with the user includes a designated transfer operation of a parallel chain element in an application parallel chain, transfers the parallel chain element of a user account to a designated account corresponding to an application, to achieve designated transfer of the parallel chain element of the application parallel chain in the user account, and facilitate interaction between the user and other users of the application.

### Embodiment VI

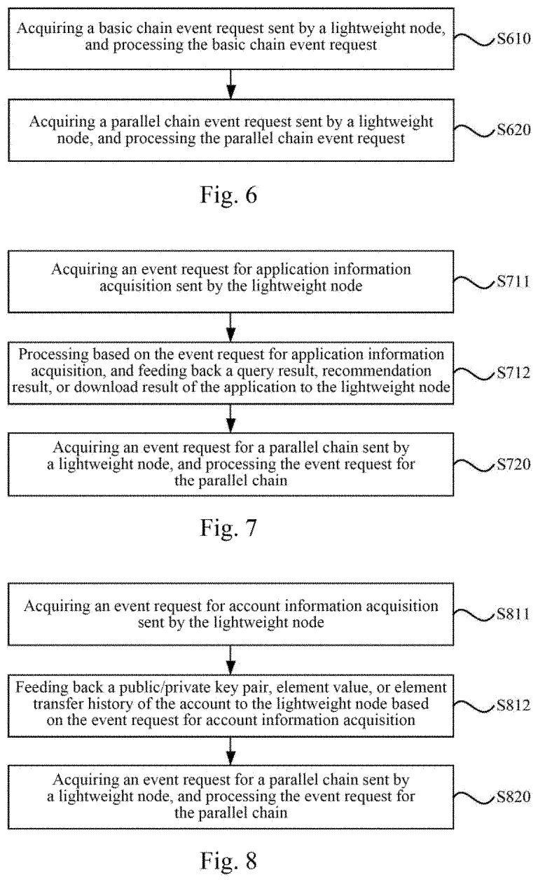

FIG. 6 is a flowchart of a method for implementing an application based on a blockchain network in Embodiment VI of the present disclosure. The embodiment of the present disclosure is adapted to implement a case where an electronic device carrying a block generation node acquires and processes event requests generated when interacting with a user via a blockchain platform access interface carried by a lightweight node locally configured in a terminal device and when interacting with the user via an application client carried by the lightweight node. The method is executed by an apparatus for implementing an application based on a blockchain network. The apparatus is implemented by software and/or hardware, and is specifically configured in an electronic device carrying a blockchain node.

The method for implementing an application based on a blockchain network as shown in FIG. 6 includes the following steps S610 and S620.

S610 includes acquiring a basic chain event request sent by a lightweight node, and processing the basic chain event request.

The basic chain event request includes data of interacting a basic operation with a user via a blockchain platform access interface carried by the lightweight node locally configured in the terminal device.

Exemplarily, the interacting a basic operation with a user may include at least one of the following items: user account registration, user account login, information query or recommendation of an application issued in a basic chain, application downloading, or management of an element within an account.

Accordingly, the data of interacting a basic operation with a user includes at least one of the following items: account information for user account registration, account login, or management of an element within an account, or query information, recommendation information, or download information of the application issued in the basic chain.

Specifically, when the user executes a basic operation on the blockchain platform access interface in the terminal device, the terminal device generates corresponding interaction data based on the basic operation of the user, adds the interaction data into a basic chain event request, and then transmits the basic chain event request in a basic chain network. The network node in the basic chain acquires the basic chain event request, and processes the basic chain event request.

S620 includes acquiring a parallel chain event request sent by a lightweight node, and processing the parallel chain event request.

The parallel chain event request includes data of interacting an application operation with the user via an application client carried by the lightweight node locally configured in the terminal device.

Exemplarily, the interacting an application operation with the user may include at least one of the following items: an information query operation of the application parallel chain, a transfer operation of a parallel chain element in the application parallel chain, or an exchange operation of the parallel chain element in the application parallel chain. Accordingly, the data of interacting an application operation with the user includes at least one of the following items: to-be-queried information of the application parallel chain, or data of transferring the parallel chain element from a user account to a designated account corresponding to the application.

Specifically, when the user executes an application operation at the application client in the terminal device, the terminal device generates corresponding interaction data based on the application operation of the user, adds the interaction data into an parallel chain event request, and then transmits the parallel chain event request in a parallel chain network. The network node in the parallel chain acquires the parallel chain event request, and processes the parallel chain event request.

The blockchain node is deployed with both deployment data of the basic chain and deployment data of at least one application parallel chain.

The deployment data may be data corresponding to a data layer, a network layer, a consensus layer, a stimulation layer, a contract layer, and an application layer in the blockchain, e.g., the data such as a data block, a timestamp, a propagation mechanism, an authentication mechanism, an issue mechanism, an algorithm mechanism, a smart contract, or a programmable currency.

It should be noted that the blockchain node, when participating in a superchain network, is deployed with deployment data of the basic chain and deployment data of at least one application parallel chain. Therefore, the blockchain node can interact data with a basic chain node in the blockchain network (specifically the basic chain network) through the deployment data of the basic chain, and can also interact data with a parallel chain node in the blockchain network (specifically the parallel chain network) through the deployment data of the parallel chain.

According to the embodiment of the present disclosure a basic chain event request sent by a lightweight node is acquired, and processed through a blockchain node, where the basic chain event request includes data of interacting a basic operation with a user via a blockchain platform access interface carried by the lightweight node locally configured in a terminal device; and a parallel chain event request sent by the lightweight node is acquired, and processed through the blockchain node, where the parallel chain event request includes data of interacting an application operation with the user via an application client carried by the lightweight node locally configured in the terminal device. The above technical solutions implement a blockchain platform based on a lightweight node architecture of an application and supernetwork technology, such that a blockchain node deployed with both deployment data of a basic chain and deployment data of at least one application parallel chain is deployed in the blockchain network to interact data through the blockchain platform carried by a lightweight node and an application client carried by the lightweight node, and enable the blockchain platform to directly provide a user with application services, and achieve distribution, promotion and management of applications, whilst enable the user to acquire bottom-layer blockchain information of the installed application.

### Embodiment VII

FIG. 7 is a flowchart of a method for implementing an application based on a blockchain network in Embodiment VII of the present disclosure. The embodiment of the present disclosure is further specified and optimized based on the above embodiments.

Further, when interaction data of the basic operation is query information, recommendation information, or download information of the application, accordingly, the “acquiring a basic chain event request sent by a lightweight node, and processing the basic chain event request” is specified as “acquiring an event request for application information acquisition sent by the lightweight node; and feeding back a query result, recommendation result, or download result of the application to the lightweight node based on the event request for application information acquisition,” to achieve providing the user with application services through the blockchain platform directly based on query demand, recommendation demand, or download demand of the user, and achieve distribution and promotion of applications.

The method for implementing an application based on a blockchain network as shown in FIG. 7 includes the following steps S711 to S720.

S711 includes acquiring an event request for application information acquisition sent by the lightweight node.

The application information includes the query information, the recommendation information, or the download information of the application.

S712 includes processing based on the event request for application information acquisition, and feeding back a query result, recommendation result, or download result of the application to the lightweight node.

When the basic operation is an information query operation of the application, the terminal device adds query information of the application, as the interaction data of the basic operation, into the event request for application information acquisition through deployment data of the basic chain deployed in the lightweight node, and transmits the request for application information acquisition in the basic chain network. The query information may be a query instruction formed by querying basic information of an application installed in a terminal device, for example, a query instruction, such as name, version, installation time, or brief introduction of functions, of the application. The query information may alternatively be a query instruction formed by querying bottom-layer information of an application parallel chain corresponding to the installed application, for example, a query instruction, such as creation time, block height, parallel chain node information, or element information of the application parallel chain.

After receiving the event request for application information acquisition including the query information, a block generation node in the basic chain not only processes the event request for application information acquisition, generates corresponding event data, and stores the event data in a block, but also feeds back a corresponding application query result to the lightweight node sending the event request for application information acquisition, and displays the application query result via the blockchain platform access interface. The query result may be basic information of an application, such as name, version, installation time, brief introduction of functions, or the like of the application; and may alternatively be bottom-layer information of an application parallel chain, such as creation time, block height, parallel chain node information, element information, or the like of the application parallel chain.

When the basic operation is a recommendation operation of the application, the terminal device adds the recommendation information of the application, as the interaction data of the basic operation, into the event request for application information acquisition through deployment data of the basic chain deployed in the lightweight node, and transmits the request for application information acquisition in the basic chain network. The recommendation information may be a recommendation instruction such as a hot list, a friend download list, a weekly hot recommendation list, a latest release, or application classification.

After receiving the event request for application information acquisition including the recommendation information, the block generation node in the basic chain not only processes the event request for application information acquisition, generates corresponding event data, and stores the event data in a block, but also feeds back a corresponding application recommendation result to the lightweight node sending the event request for application information acquisition, and displays the application recommendation result via the blockchain platform access interface. The recommendation result may be a download link of the application or the application itself; and deployment data of the application parallel chain corresponding to the application.

When the basic operation is a download operation of the application, the terminal device adds download information of the application, as the data of the basic operation, into the event request for application acquisition through the deployment data of the basic chain deployed in the lightweight node, and transmits the event request for application information acquisition in the basic chain network. The download information may be at least one download instruction of the application, corresponding to a hot list, a friend download list, a weekly hot recommendation list, a latest release, or application classification.

After receiving the event request for application information acquisition including the download information, the block generation node in the basic chain network not only processes the event request for application information acquisition, generates corresponding event data, and stores the event data in a block, but also feeds back a corresponding application download result to the lightweight node sending the event request for application information acquisition, and displays the application download result via the blockchain platform access interface. The download result may be a download link of the application or the application itself; and the deployment data of the application parallel chain corresponding to the application.

It should be noted that, whilst downloading and installing the application by triggering the download link or the application itself, the user also correspondingly stores the deployment data of the application parallel chain corresponding to the application. Here, the lightweight node configured in the terminal device where the application is installed can be used as network nodes of the blockchain network of the application parallel chain corresponding to the application, to interact data with other nodes in the application parallel chain network.

S720 includes acquiring a parallel chain event request sent by a lightweight node, and processing the parallel chain event request.

The parallel chain event request includes data of interacting an application operation with the user via an application client carried by the lightweight node locally configured in the terminal device.

The blockchain node is deployed with both deployment data of the basic chain and deployment data of at least one application parallel chain.

According to the embodiment of the present disclosure, when interaction data of a basic operation is specified as query information, recommendation information or download information of an application, an event request for application information acquisition corresponding to the interaction data of the basic operation sent by a lightweight node is acquired, a query result, recommendation result, or download result of the application is fed back to the lightweight node by processing the event request for application information, and the query result, the recommendation result, or the download result of the application is displayed by a blockchain node. The above technical solutions achieve providing a user with application services through the blockchain platform directly based on the query demand, recommendation demand, or download demand of the user, and achieve distribution and promotion of applications.

Based on the technical solutions of the above embodiments, further, when the interaction data of the basic operation are the download information of the application, accordingly, the processing based on the event request for application information acquisition includes:

transferring a basic chain element from a user account to a designated account corresponding to the application based on the event request for application information acquisition; where the designated account is an administrator account of the blockchain network or an operator account of the application; and

acquiring the download result based on the download information in the event request for application information acquisition, and feeding back the download result to the lightweight node.

The basic chain element may be a digital currency circulated in the blockchain network for stimulating users. For example, the basic chain element may be a bitcoin, point, stardiamond, energy, or the like. In the basic chain, not only digital currency, but also other currency unit that can be managed by an account have a stimulation effect.

The basic chain and the application parallel chain may use same or different types of digital currencies for stimulation. For network nodes of the basic chain and the parallel chain, accounts for storing elements can store various types of digital currencies. The digital currency in each blockchain can interact with the account, such as transferring in or out a digital currency.

The account can be managed by an asymmetric key pair, the public key is an account address, and the private key is saved by an account owner himself.

Specifically, when the basic operation is downloading of the application, the download information of the application, beneficiary account, payer account, to-be-transferred element type and to-be-transferred element amount are added into the event request for application information acquisition through the deployment data of the basic chain deployed in the lightweight node, and the event request for application information acquisition are transmitted in the basic chain network.

After receiving the event request for application information acquisition, a blockchain network node in the basic chain network not only processes the event request for application information acquisition, generates corresponding event data, and stores the event data in a block, but also transfers a set amount of a to-be-transferred element of a set type from the payer account to the beneficiary account. The set type is a type of the to-be transferred element, and the set amount is only an amount of the to-be-transferred element.

The beneficiary account is the administrator account of the blockchain network or the operator account of the application; the payer account is a user account; the type of the to-be-transferred element is the basic chain element; and the amount of the to-be-transferred element is an amount corresponding the application and preset by the blockchain network administrator or the application operator.

In the embodiment of the present disclosure, when a user downloads an application based on a blockchain platform, data of transferring a basic chain element from a user account to a designated account corresponding to the application is added into the event request for application information acquisition, and when a blockchain node processes the event request for application information acquisition, the transferring operation of the basic chain element are executed accordingly, enabling the user account to effect certain payment to the administrator account of the blockchain network or the operator account of the application when downloading information.

### Embodiment VIII

FIG. 8 is a flowchart of a method for implementing an application based on a blockchain network in Embodiment VIII of the present disclosure. The embodiment of the present disclosure is further specified and optimized based on the above embodiments.

Further, when interaction data of the basic operation is account information for user account registration, user account login, and management of an element within an account, accordingly, the “acquiring an event request for a basic chain sent by a lightweight node, and processing the basic chain event request” is specified as “acquiring an event request for application information acquisition sent by the lightweight node; and feeding back a public/private key pair, element value, or element transfer history of the account to the lightweight node based on the event request for account information acquisition,” to achieve directly providing the user with application services through the blockchain platform, and achieve management of applications.

The method for implementing an application based on a blockchain network as shown in FIG. 8 includes the following steps S811 to S820.

S811 includes acquiring an event request for account information acquisition sent by the lightweight node.

The event request for account information acquisition includes account information for user account registration, user account login, or management of an element within an account.

S812 includes feeding back a public/private key pair, element value, or element transfer history of the account to the lightweight node based on the event request for account information acquisition.

The account is managed by a public/private key pair, i.e., an asymmetric key pair, the public key is an account address, and the private key is saved by an account owner himself.

When the basic operation is account registration, the terminal device adds pre-registered account information inputted by the user, as the data of the basic operation, into the event request for account information acquisition through deployment data of the basic chain deployed in the lightweight node, and transmits the event request for account information acquisition in the basic chain network.

After receiving the event request for pre-registered account information acquisition, a blockchain node in the basic chain network not only processes the event request for account information acquisition, generates corresponding event data, and stores the event data in a block, but also feeds back the public/private key pair of the account to the lightweight node sending the event request for account information acquisition, and displays the public/private key pair of the account via the blockchain platform access interface. The pre-registered account information at least includes a public key as the account address.

When the basic operation is account login, the terminal device adds registered account information inputted by the user, as the data of the basic operation, into the event request for account information acquisition through the deployment data of the basic chain deployed in the lightweight node, and transmits the event request for account information acquisition in the basic chain network.

After receiving the event request for registered account information acquisition, the block generation node in the basic chain network not only processes the event request for account information acquisition, generates corresponding event data, and stores the event data in a block, but also compares the registered account information with the private key, and permit the user to log in the corresponding account based on the registered account information when the comparison result is successful. The registered account information at least includes the private key saved by the account owner himself.

When the basic operation is management of an element within an account, the terminal device adds the registered account information inputted by the user and account management information, as the data of the basic operation, into the event request for account information acquisition through the deployment data of the basic chain deployed in the lightweight node, and transmits the event request for account information acquisition in the basic chain network. The account management information may be element balance query information of the application, or element transfer history query information of the application, or the like.

After receiving the event request for registered account information acquisition, the block generation node in the basic chain network only processes the event request for account information acquisition, generates corresponding event data, and stores the event data in a block, but also feeds back the element value or element transfer history, or the like of the account to the lightweight node sending the event request for account information acquisition, and displays the element value or element transfer history, or the like of the account via the blockchain platform access interface.

S820 includes acquiring an event request for a parallel chain sent by a lightweight node, and processing the parallel chain event request.

The parallel chain event request includes data of interacting an application operation with the user via an application client carried by the lightweight node locally configured in the terminal device.

The blockchain node is deployed with both deployment data of the basic chain and deployment data of at least one application parallel chain.

According to the embodiment of the present disclosure, when interacting data of a basic operation is specified as account information for user account registration, user account login, and management of an element within an account, a blockchain node acquires an event request for account information acquisition of a lightweight node, and feeds back a public/private key pair, element value, or element transfer history of the account to the lightweight node based on the event request for account information acquisition. The above technical solutions achieve providing a user with application services through the blockchain platform directly based on query demand, recommendation demand, or download demand of the user, and achieve management of applications.

### Embodiment IX

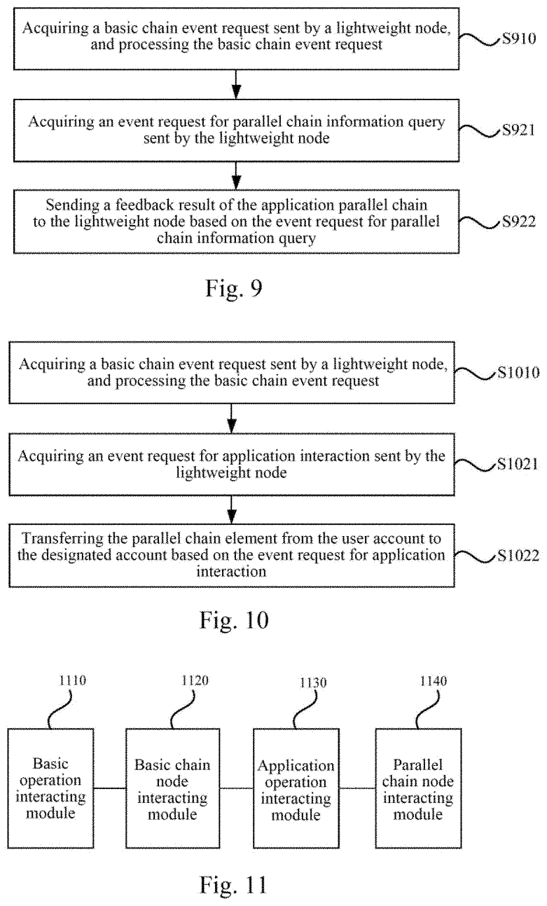

FIG. 9 is a flowchart of a method for implementing an application based on a blockchain network in Embodiment IX of the present disclosure. The embodiment of the present disclosure is further specified and optimized based on the above embodiments.

Further, when the interacting an application operation with the user includes to-be-queried information of the application parallel chain, accordingly, the “acquiring an event request for a parallel chain sent by a lightweight node, and processing the parallel chain event request” is specified as “acquiring an event request for parallel chain information query sent by the lightweight node; and sending a feedback result of the application parallel chain to the lightweight node based on the event request for parallel chain information query; where the feedback result of the application parallel chain includes creation time, block height, parallel chain node information, and element information of the application parallel chain,” to enable the user to acquire bottom-layer blockchain information of the installed application.

The method for implementing an application based on a blockchain network as shown in FIG. 9 includes the following steps S910 to S922.

S910 includes acquiring a basic chain event request sent by a lightweight node, and processing the basic chain event request.

The basic chain event request includes data of interacting a basic operation with a user via a blockchain platform access interface carried by the lightweight node locally configured in the terminal device.

S921 includes acquiring an event request for parallel chain information query sent by the lightweight node.

The event request for parallel chain information query includes to-be-queried information of the application parallel chain.

S922 includes sending a feedback result of the application parallel chain to the lightweight node based on the event request for parallel chain information query.

When the user performs an information query operation of the application parallel chain corresponding to the application through an application client, the terminal device uses to-be-queried information of the application parallel chain as the data of the application operation to generate the event request for parallel chain information query through deployment data of the parallel chain deployed in the lightweight node, and transmits the event request for parallel chain information query in a parallel chain network of the application parallel chain. The to-be-queried information includes a query instruction of bottom-layer information of the application parallel chain.

After receiving the event request for parallel chain information query, a blockchain node in the parallel chain network not only processes the event request for parallel chain information query, generates corresponding event data, and stores the event data in a block, but also sends a corresponding feedback result of the parallel chain to the lightweight node sending the event request for parallel chain information query, and displays the feedback result of the parallel chain via the application client interface. The feedback result of the parallel chain includes creation time, block height, parallel chain node information, and element information of the application parallel chain. The parallel chain node information includes a parallel chain node identifier, and the like; and the element information includes a parallel chain element type, and the like.

According to the embodiment of the present disclosure, when interacting data of an application operation with the user is specified as including to-be-queried information of the application parallel chain, a blockchain node acquires an event request for parallel chain information query including the to-be-queried information, and sends a feedback result of the application parallel chain to a lightweight node based on the event request for parallel chain information query. The above technical solutions achieve enabling a user to acquire bottom-layer information of the application parallel chain corresponding to an application installed in a terminal device through a blockchain platform directly based on parallel chain query demand of the user.

### Embodiment X

FIG. 10 is a flowchart of a method for implementing an application based on a blockchain network in Embodiment V of the present disclosure. The embodiment of the present disclosure is further specified and optimized based on the above embodiments.

Further, when data of interacting an application operation with the user include data of designated transfer of a parallel chain element in the application parallel chain, the “acquiring an event request for a parallel chain sent by a lightweight node, and processing the parallel chain event request” is specified as “acquiring an event request for application interaction sent by the lightweight node, where the event request for application interaction includes data of transferring a parallel chain element from the user account to a designated account corresponding to the application; and transferring the parallel chain element from the user account to the designated account based on the event request for application interaction,” to achieve the designated transfer of the parallel chain element of the application parallel chain in the user account when the application operation is a transfer operation of the parallel chain element, and facilitate interaction between the user and other users of the application.

The method for implementing an application based on a blockchain network as shown in FIG. 10 includes the following steps S1010 to S1022.

S1010 includes acquiring a basic chain event request sent by a lightweight node, and processing the basic chain event request.

The basic chain event request includes data of interacting a basic operation with a user via a blockchain platform access interface carried by the lightweight node locally configured in the terminal device.

S1021 includes acquiring an event request for application interaction sent by the lightweight node.

The event request for application interaction includes data of transferring a parallel chain element from a user account to a designated account corresponding to the application.

S1022 includes transferring the parallel chain element from the user account to the designated account based on the event request for application interaction.

When interacting an application operation with the user via an application client includes a transfer operation of the parallel chain element in the application parallel chain, a beneficiary account, a payer account, a to-be-transferred element type and a to-be-transferred element amount are used as designated transfer data to form an event request for application interaction through deployment data of the application parallel chain deployed in the lightweight node, and the event request for application interaction is transmitted to the parallel chain network.

After receiving the event request for application interaction, a blockchain node in the parallel chain network not only processes the event request for application interaction, generates corresponding event data, and stores the event data in a block, but also transfers a set amount of a to-be-transferred element of a set type from the payer account to the beneficiary account. The set type is a type of the to-be transferred element, and the set amount is only an amount of the to-be-transferred element.

The beneficiary account is the designated account corresponding to the application, for example, may be a friend account of a user account; the payer account is a user account; the to-be-transferred element type is a parallel chain element corresponding to the application; and the to-be-transferred element amount is an amount set by the user himself.

According to the embodiment of the present disclosure, when data of interacting an application operation with the user includes data of designated transfer of a parallel chain element in an application parallel chain, an event request for application interaction sent by a lightweight node is acquired, and the parallel chain element is transferred from a user account to the designated account based on the event request for application interaction; where the event request for application interaction includes data of transferring the parallel chain element from the user account to the designated account corresponding to the application. The above technical solutions achieve the designated transfer of the parallel chain element of the application parallel chain in the user account, and facilitate interaction between the user and other users of the application.

### Embodiment XI

FIG. 11 is a structural diagram of an apparatus for implementing an application based on a blockchain network in Embodiment XI of the present disclosure. The embodiment of the present disclosure is adapted to implement data interaction between network nodes of a basic chain and/or parallel chain in the blockchain network, when interacting with a user via a blockchain platform access interface carried by a lightweight node, and when interacting with the user via an application client carried by the lightweight node. The apparatus is implemented by software and/or hardware, and is specifically configured in a terminal device that is provided with a lightweight node and is provided with an application based on the blockchain network. The apparatus for implementing an application based on a blockchain network shown in FIG. 11 includes: a basic operation interacting module 1110, a basic chain node interacting module 1120, an application operation interacting module 1130, and a parallel chain node interacting module 1140.

The basic operation interacting module 1110 is configured to interact a basic operation with a user.

The basic chain node interacting module 1120 is configured to interact data of the basic operation with a basic chain node in the blockchain network through data of a basic chain deployed in the lightweight node.

The application operation interacting module 1130 is configured to interact an application operation with the user.

The parallel chain node interacting module 1140 is configured to interact data of the application operation with a node of an application parallel chain corresponding to the application through data of the application parallel chain deployed in the lightweight node.

According to the embodiment of the present disclosure, a basic operation interacting module interacts a basic operation with a user; a basic chain node interacting module interacts data of the basic operation with a basic chain node in the blockchain network through data of a basic chain deployed in a lightweight node; interacts an application operation with the user; and a parallel chain node interacting module interacts data of the application operation with a node of an application parallel chain corresponding to the application through data of the application parallel chain deployed in the lightweight node. The above technical solutions implement a blockchain platform based on a lightweight node architecture of an application and a supernetwork technology, to directly provide a user with application services through the blockchain platform, and achieve distribution, promotion and management of applications.

Further, at least a part of nodes in the blockchain network are deployed with both deployment data of the basic chain and deployment data of at least one application parallel chain.

Further, the interacting a basic operation with a user includes at least one of the following items:

user account registration, user account login, information query or recommendation of an application issued in the basic chain, application downloading, or management of an element within an account.

Further, if the basic operation is information query, recommendation, or downloading of the application, then the basic chain node interacting module 1120 includes the following units:

a first event request transmitting unit, configured to add query information, recommendation information, or download information of the application, as the data of the basic operation, into the event request for application information acquisition through the data of the basic chain deployed in the lightweight node, and transmit the event request for application information acquisition to the blockchain network; and

a first receiving unit, configured to receive a query result, recommendation result, or download result of the application fed back from the blockchain network, and display the query result, recommendation result, or download result of the application.

Further, the apparatus further includes:

a first adding unit, configured to add, when the basic operation is downloading of the application, data of transferring a basic chain element from a user account to a designated account corresponding to the application into the event request for application information acquisition before the transmitting the event request for application information acquisition.

The designate account is an administrator account of the blockchain network or an operator account of the application.

Further, the download result includes:

a download link of the application or the application itself; and deployment data of the application parallel chain corresponding to the application.

Further, if the basic operation is account registration, account login, or management of an element within an account, then the basic chain node interacting module 1120 includes:

a second event request transmitting unit, configured to add account information, as the data of the basic operation, into an event request for account information acquisition through the data of the basic chain deployed in the lightweight node, and transmit the event request for account information acquisition to the blockchain network; and

a second receiving unit, configured to receive a public/private key pair, element value, or element transfer history of the account fed back from the blockchain network, and display the public/private key pair, element value, or element transfer history of the account.

Further, if the interacting an application operation with the user includes an information query operation of the application parallel chain, then the parallel chain node interacting module 1140 includes:

a third event request transmitting unit, configured to use to-be-queried information of the application parallel chain as the data of the application operation to generate an event request for parallel chain information query through the data of the application parallel chain deployed in the lightweight node, and transmit the event request for parallel chain information query to the blockchain network; and

a third receiving unit, configured to receive a feedback result of the application parallel chain from the blockchain network, and display the feedback result of the application parallel chain.

The feedback result of the application parallel chain includes creation time, block height, parallel chain node information, and element information of the application parallel chain.

Further, the parallel chain node interacting module 1140 includes:

a fourth event request transmitting unit, configured to use the data of the application operation to form an event request for application interaction through the data of the application parallel chain deployed in the lightweight node, and transmit the event request for application interaction to the blockchain network, where the event request for application interaction includes data of transferring a parallel chain element from the user account to a designated account corresponding to the application.

The apparatus for implementing an application based on a blockchain network can execute the method for implementing an application based on a blockchain network provided in any embodiment of the present disclosure, and has corresponding functional modules for executing the method for implementing an application based on a blockchain network, and beneficial effects. The technical details that are not described in detail in the present embodiment, may refer to the method for implementing a blockchain network provided in any embodiment of the present disclosure.

### Embodiment XII

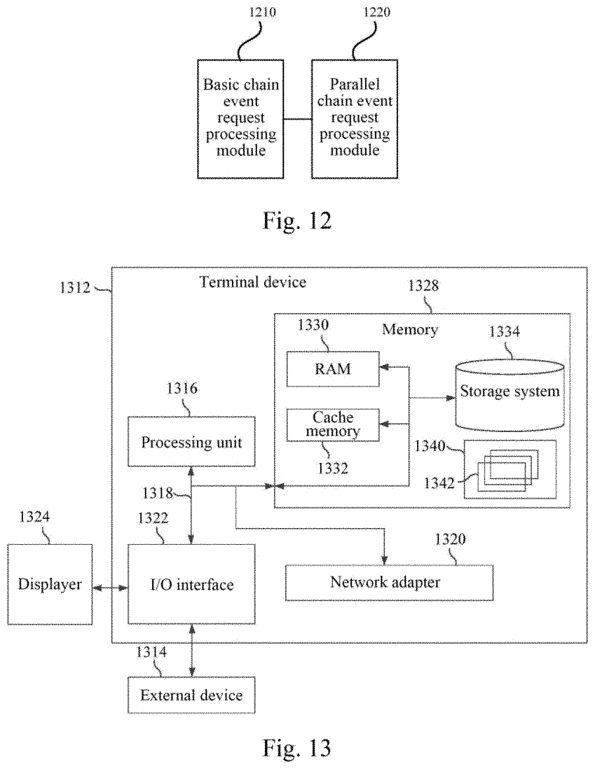

FIG. 12 is a structural diagram of an apparatus for implementing an application based on a blockchain network in Embodiment XII of the present disclosure. The embodiment of the present disclosure is adapted to implement a case where an electronic device carrying a block generation node acquires and processes event requests generated when interacting with a user via a blockchain platform access interface carried by a lightweight node locally configured in a terminal device and when interacting with the user via an application client carried by the lightweight node. The apparatus is implemented by software and/or hardware, and is specifically configured in an electronic device carrying a blockchain node. The apparatus shown in FIG. 12 includes: a basic chain event request processing module 1210 and a parallel chain event request processing module 1220.

The basic chain event request processing module 1210 is configured to acquire a basic chain event request sent by a lightweight node, and process the basic chain event request, where the basic chain event request includes data of interacting a basic operation with a user via a blockchain platform access interface carried by the lightweight node locally configured in a terminal device.

The parallel chain event request processing module 1220 is configured to acquire a parallel chain event request sent by the lightweight node, and process the parallel chain event request, where the parallel chain event request includes data of interacting an application operation with the user via an application client carried by the lightweight node locally configured in the terminal device.

The blockchain node is deployed with both deployment data of the basic chain and deployment data of at least one application parallel chain.

According to the embodiment of the present disclosure, a basic chain event request processing module acquires a basic chain event request sent by a lightweight node, and processes the basic chain event request, where the basic chain event request includes data of interacting a basic operation with a user via a blockchain platform access interface carried by the lightweight node locally configured in a terminal device; and a parallel chain event request processing module acquires a parallel chain event request sent by the lightweight node, and processes the parallel chain event request, where the parallel chain event request includes data of interacting an application operation with the user via an application client carried by the lightweight node locally configured in the terminal device. The blockchain node is deployed with both deployment data of the basic chain and deployment data of at least one application parallel chain. The above technical solutions implement a blockchain platform based on a lightweight node architecture of an application and a supernetwork technology, such that a blockchain node is deployed with both deployment data of a basic chain and deployment data of at least one application parallel chain in the blockchain network to interact data through the blockchain platform carried by a lightweight node and an application client carried by the lightweight node, enabling the blockchain platform to directly provide a user with application services, and achieve distribution, promotion and management of applications, whilst enabling the user to acquire bottom-layer blockchain information of the installed application.

Further, the data of interacting a basic operation with a user includes at least one of:

account information for user account registration, account login, or management of an element within an account, or query information, recommendation information, or download information of the application issued in the basic chain.

Further, the basic chain event request processing module 1210 includes:

a first event request acquiring unit, configured to acquire an event request for application information acquisition sent by the lightweight node; where the application information includes the query information, the recommendation information, or the download information of the application; and

a first feedback unit, configured to perform processing based on the event request for application information acquisition, and feed back a query result, recommendation result, or download result of the application to the lightweight node.

Further, if the event request for application information acquisition includes download information of the application, then the first feedback unit is specifically configured to:

transfer a basic chain element from a user account to a designated account corresponding to the application based on the event request for application information acquisition; where the designated account is an administrator account of the blockchain network or an operator account of the application; and

acquire the download result based on the download information in the event request for application information acquisition, and feed back the download result to the lightweight node.

Further, the download result includes:

a download link of the application or the application itself; and deployment data of the application parallel chain corresponding to the application.

Further, the basic chain event request processing module 1210 includes:

a second event request acquiring unit, configured to acquire an event request for account information acquisition sent by the lightweight node; where the event request for account information acquisition includes the account information for user account registration, user account login, and management of an element within the account; and

a second feedback unit, configured to feed back a public/private key pair, element value, or element transfer history of the account to the lightweight node based on the event request for account information acquisition.

Further, the parallel chain event request processing module 1220 includes:

a third event request acquiring unit, configured to acquire an event request for parallel chain information query sent by the lightweight node; where the event request for parallel chain information query includes to-be-queried information of the application parallel chain; and

a third feedback unit, configured to send a feedback result of the application parallel chain to the lightweight node based on the event request for parallel chain information query.

The feedback result of the application parallel chain includes creation time, block height, parallel chain node information, and element information of the application parallel chain.

Further, the parallel chain event request is an event request for application interaction.

Accordingly, the parallel chain event request processing module 1220 includes:

a fourth event request acquiring unit, configured to acquire an event request for application interaction sent by the lightweight node, where the event request for application interaction includes data of transferring a parallel chain element from the user account to a designated account corresponding to the application; and

a parallel element transferring unit, configured to transfer the parallel chain element from the user account to the designated account based on the event request for application interaction.

The apparatus for implementing an application based on a blockchain network can execute the method for implementing an application based on a blockchain network provided in any embodiment of the present disclosure, and has corresponding functional modules for executing the method for implementing an application based on a blockchain network, and beneficial effects. The technical details that are not described in detail in the present embodiment, may refer to the method for implementing a blockchain network provided in any embodiment of the present disclosure.

### Embodiment XIII

FIG. 13 is a structural diagram of a terminal device provided in Embodiment XIII of the present disclosure. FIG. 13 shows a block diagram of an exemplary terminal device 1312 adapted to implement the embodiments of the present disclosure. The terminal device 1312 shown in FIG. 13 is merely an example, and should not limit the functions and scope of use of the embodiments of the present disclosure.

As shown in FIG. 13, the terminal device 1312 is expressed in the form of a general-purpose computing device. Components of the terminal device 1312 may include, but are not limited to: one or more processors or a processing unit 1316, a system memory 1328, and a bus 1318 connecting different system components (including the system memory 1328 and the processing unit 1316).

The bus 1318 represents one or more of a few bus structures, including a memory bus or a memory controller, a peripheral bus, a graphics acceleration port, a processor, or a local bus with any bus structure of a plurality of bus structures. For example, the system structures include, but are not limited to, an industrial standard architecture (ISA) bus, a micro channel architecture (MAC) bus, an enhanced ISA bus, a Video Electronics Standards Association (VESA) local bus, and a peripheral component interconnect (PCI) bus.

The terminal device 1312 typically includes a plurality of computer system readable media. These media may be any available medium that can be accessed by the terminal device 1312, including volatile media, non-volatile media, removable media, and non-removable media.

The system memory 1328 may include a computer system readable medium in the form of a volatile memory, such as a random access memory (RAM) 1330 and/or a cache memory 1332. The terminal device 1312 may further include other removable/non-removable, and volatile/non-volatile computer system storage media. By way of example only, a storage system 1334 can be used for reading from and writing in non-removable and nonvolatile magnetic media (not shown in FIG. 13, generally known as a “hard drive”). A disk drive for reading from and writing in a removable non-volatile disk (such as a “floppy disk”) and an optical driver for reading from and writing in a removable non-volatile disk (such as CD-ROM, DVD-ROM, or other optical media) may be provided, though the disk drive or the optical driver is not shown in FIG. 13. Under the circumstances, each drive may be connected to the bus 1318 through one or more data media interfaces. The memory 1328 may include at least one program product, the program product has a set of (e.g., at least one) program modules, and the program modules are configured to execute the functions of the embodiments of the present disclosure.

A program/utility software 1340 with a set of (at least one) program modules 1342 can be stored in, e.g., the memory 1328. Such a program module 1342 includes, but is not limited to, an operating system, one or more application programs, other program modules, and program data. Each of these examples or a combination thereof may include implementation of a network environment. The program module 1342 generally executes the functions and/or methods in the embodiments according to the present disclosure.

The terminal device 1312 may also communicate with one or more external devices 1314 (e.g., a keyboard, a pointing device, and a displayer 1324), and may also communicate with one or more devices that enable a user to interact with the terminal device 1312, and/or communicate with any device (e.g., a network card and a modem) that enables the terminal device 1312 to communicate with one or more of other computing devices. Such communication can be performed through an input/output (I/O) interface 1322. Moreover, the terminal device 1312 may further communicate with one or more networks (e.g., a local area network (LAN), a wide area network (WAN), and/or a public network such as the Internet) through a network adapter 1320. As shown in the figure, the network adapter 1320 communicates with other modules of the terminal device 1312 through the bus 1318. It should be appreciated that other hardware and/or software modules may be used in combination with the terminal device 1312, including but not limited to: a microcode, a device driver, a redundancy processing unit, an external disk drive array, a RAID system, a tape drive, a data backup storage system, and the like, though the modules are not shown in the figure.

The processing unit 1316 executes various functional applications and data processing by running at least one of other programs among a plurality of programs stored in the system memory 1328, such as implementing the method for implementing an application based on a blockchain network provided in the embodiments of the present disclosure.

### Embodiment XIV

Embodiment XIV of the present disclosure further provides an electronic device. The structural diagram of the electronic device may also refer to FIG. 13.

This embodiment of the present disclosure is different from Embodiment XIII only in that: the processing unit 1316 executes various functional applications and data processing by running a program stored in the system memory 1328, such as implementing the method for implementing an application based on a blockchain network provided in the embodiments of the present disclosure.

### Embodiment XV

Embodiment XV of the present disclosure provides a computer readable storage medium, storing a computer program thereon, where the program, when executed by a processor, implements the method for implementing an application based on a blockchain network provided in any embodiment of the present disclosure. The method includes: interacting a basic operation with a user via a blockchain platform access interface carried by a lightweight node locally configured in a terminal device; interacting data of the basic operation with a basic chain node in the blockchain network through data of a basic chain deployed in the lightweight node; interacting an application operation with the user through an application client locally installed in the terminal device; and interacting data of the application operation with a node of an application parallel chain corresponding to the application through data of the application parallel chain deployed in the lightweight node.

The embodiment of the present disclosure further provides another computer readable storage medium, storing a computer program thereon, where the program, when executed by a processor, implements the method for implementing an application based on a blockchain network provided in any embodiment of the present disclosure. The method includes: acquiring a basic chain event request sent by a lightweight node, and processing the basic chain event request, where the basic chain event request includes data of interacting a basic operation with a user via a blockchain platform access interface carried by the lightweight node locally configured in a terminal device; and acquiring a parallel chain event request sent by the lightweight node, and processing the parallel chain event request, where the parallel chain event request includes data of interacting an application operation with the user via an application client carried by the lightweight node locally configured in the terminal device. The blockchain node is deployed with both deployment data of the basic chain and deployment data of at least one application parallel chain.

Any combination of one or more computer readable media may be used as the computer storage medium of the embodiments of the present disclosure. The computer readable medium may be a computer readable signal medium or a computer readable storage medium. An example of the computer readable storage medium may include, but is not limited to: an electric, magnetic, optical, electromagnetic, infrared, or semiconductor system, apparatus, element, or a combination of any of the above. A more specific example (non-enumerated list) of the computer readable storage medium may include, but is not limited to: electrical connection with one or more wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. Herein, the computer readable storage medium may be any tangible medium containing or storing programs which may be used by a command execution system, apparatus, or element or incorporated thereto.

The computer readable signal medium may include data signal in the base band or propagating as a part of a carrier wave, in which computer readable program codes are carried. The propagating data signal may take various forms, including but not limited to: an electromagnetic signal, an optical signal or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element.

The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

It should be noted that, the above description only provides preferred embodiments of the present disclosure and the employed technical principles. It should be appreciated by those skilled in the art that the present disclosure is not limited to the specific embodiments described herein. Those skilled in the art can make various obvious changes, readjustments, and replacements without departing from the scope of protection of the present disclosure. Therefore, while the present disclosure is illustrated in detail in combination with the above embodiments, the present disclosure is not only limited to the above embodiments, and can further include more other equivalent embodiments without departing from the concept of the present disclosure. The scope of the present disclosure is defined by the scope of the appended claims.

What is claimed is:

1. A method for implementing an application based on a blockchain network, applied to a terminal device, the method comprising:
interacting a basic operation with a user via a blockchain platform access interface carried by a lightweight node locally configured in a terminal device;
interacting data of the basic operation with a basic chain node in the blockchain network through data of a basic chain deployed in the lightweight node;
interacting an application operation with the user through an application client locally installed in the terminal device; and
interacting data of the application operation with a node of an application parallel chain corresponding to the application through data of the application parallel chain deployed in the lightweight node.

2. The method according to claim 1, wherein
at least a part of nodes in the blockchain network are deployed with both deployment data of the basic chain and deployment data of at least one of the application parallel chain.

3. The method according to claim 1, wherein the interacting a basic operation with a user comprises at least one of following items:
user account registration, user account login, information query or recommendation of the application issued in the basic chain, application downloading, or management of an element within an account.

4. The method according to claim 3, wherein if the basic operation is the information query, recommendation, or downloading of the application, then the interacting data of the basic operation with a basic chain node in the blockchain network through data of a basic chain deployed in the lightweight node comprises:
adding query information, recommendation information, or download information of the application, as the data of the basic operation, into an event request for application information acquisition through the data of the basic chain deployed in the lightweight node, and transmitting the event request for application information acquisition to the blockchain network; and
receiving a query result, recommendation result, or download result of the application fed back from the blockchain network, and displaying the query result, recommendation result, or download result of the application.

5. The method according to claim 4, wherein if the basic operation is the downloading of the application, then before the transmitting the event request for application information acquisition, the method further comprises:
adding data of transferring a basic chain element from a user account to a designated account corresponding to the application into the event request for application information acquisition;
wherein the designated account is an administrator account of the blockchain network or an operator account of the application.

6. The method according to claim 4, wherein the download result comprises:
a download link of the application or the application itself; and deployment data of the application parallel chain corresponding to the application.

7. The method according to claim 3, wherein if the basic operation is the account registration, account login, or management of an element within an account, then the interacting data of the basic operation with a basic chain node in the blockchain network through data of a basic chain deployed in the lightweight node comprises:
adding account information, as the data of the basic operation, into an event request for account information acquisition through the data of the basic chain deployed in the lightweight node, and transmitting the event request for account information acquisition to the blockchain network; and
receiving a public/private key pair, element value, or element transfer history of the account fed back from the blockchain network, and displaying the public/private key pair, element value, or element transfer history of the account.

8. The method according to claim 1, wherein if the interacting an application operation with the user includes an information query operation of the application parallel chain, then the interacting data of the application operation with a node of an application parallel chain corresponding to the application through data of the application parallel chain deployed in the lightweight node comprises:
using to-be-queried information of the application parallel chain as the data of the application operation to generate an event request for parallel chain information query through the data of the application parallel chain deployed in the lightweight node, and transmitting the event request for parallel chain information query to the blockchain network; and
receiving a feedback result of the application parallel chain from the blockchain network, and displaying the feedback result of the application parallel chain;
wherein the feedback result of the application parallel chain comprises creation time, block height, parallel chain node information, and element information of the application parallel chain.

9. The method according to claim 1, wherein the interacting data of the application operation with a node of an application parallel chain corresponding to the application through data of the application parallel chain deployed in the lightweight node comprises:
using the data of the application operation to form an event request for application interaction through the data of the application parallel chain deployed in the lightweight node, and transmitting the event request for application interaction to the blockchain network, wherein the event request for application interaction comprises data of transferring a parallel chain element from the user account to a designated account corresponding to the application.

10. A method for implementing an application based on a blockchain network, applied to a blockchain node, the method comprising:
acquiring a basic chain event request sent by a lightweight node, and processing the basic chain event request, the basic chain event request comprising data of interacting a basic operation with a user via a blockchain platform access interface carried by the lightweight node locally configured in a terminal device; and
acquiring a parallel chain event request sent by the lightweight node, and processing the parallel chain event request, the parallel chain event request comprising data of interacting an application operation with the user via an application client carried by the lightweight node locally configured in the terminal device;
wherein the blockchain node is deployed with both deployment data of the basic chain and deployment data of at least one application parallel chain.

11. The method according to claim 10, wherein the data of interacting a basic operation with a user comprises at least one of following items:
account information for user account registration, account login, or management of an element within an account, or query information, recommendation information, or download information of the application issued in the basic chain.

12. The method according to claim 11, wherein the acquiring a basic chain event request sent by a lightweight node, and processing the basic chain event request comprises:
acquiring an event request for application information acquisition sent by the lightweight node; wherein the application information comprises the query information, the recommendation information, or the download information of the application; and
processing based on the event request for application information acquisition, and feeding back a query result, recommendation result, or download result of the application to the lightweight node.

13. The method according to claim 12, wherein if the application information comprises the download information of the application, then the processing based on the event request for application information acquisition comprises:
transferring a basic chain element from a user account to a designated account corresponding to the application based on the event request for application information acquisition; wherein the designated account is an administrator account of the blockchain network or an operator account of the application.
acquiring the download result based on the download information in the event request for application information acquisition, and feeding back the download result to the lightweight node.

14. The method according to claim 13, wherein the download result comprises:
a download link of the application or the application itself; and deployment data of the application parallel chain corresponding to the application.

15. The method according to claim 11, wherein the acquiring a basic chain event request sent by a lightweight node, and processing the basic chain event request comprises:
acquiring an event request for account information acquisition sent by the lightweight node; wherein the account information comprises the account information for user account registration, user account login, or management of an element within the account; and
feeding back a public/private key pair, element value, or element transfer history of the account to the lightweight node based on the event request for account information acquisition.

16. The method according to claim 10, wherein the acquiring a parallel chain event request sent by a lightweight node, and processing the parallel chain event request comprises:
acquiring an event request for parallel chain information query sent by the lightweight node; wherein the event request for parallel chain information query comprises to-be-queried information of the application parallel chain; and
sending a feedback result of the application parallel chain to the lightweight node based on the event request for parallel chain information query;
wherein the feedback result of the application parallel chain comprises creation time, block height, parallel chain node information, and element information of the application parallel chain.

17. The method according to claim 10, wherein the acquiring a parallel chain event request sent by a lightweight node, and processing the parallel chain event request comprises:
acquiring an event request for application interaction sent by the lightweight node, wherein the event request for application interaction comprises data of transferring a parallel chain element from the user account to a designated account corresponding to the application; and
transferring the parallel chain element from the user account to the designated account based on the event request for application interaction.

18. An apparatus for implementing an application based on a blockchain network, the apparatus being configured in a terminal device, a lightweight node being locally configured in the terminal device, the terminal device being provided with the application implemented based on the blockchain network, and the apparatus comprising:
at least one processor; and
a memory storing instructions, wherein the instructions when executed by the at least one processor, cause the at least one processor to perform operations, the operations comprising:
interacting a basic operation with a user;
interacting data of the basic operation with a basic chain node in the blockchain network through data of a basic chain deployed in the lightweight node;
interacting an application operation with the user; and
interacting data of the application operation with a node of an application parallel chain corresponding to the application through data of the application parallel chain deployed in the lightweight node.

19. An apparatus for implementing an application based on a blockchain network, the apparatus being configured in a blockchain node and comprising: at least one processor; and a memory storing instructions, wherein the instructions when executed by the at least one processor, cause the at least one processor to perform the method according to claim 10.

20. A computer readable storage medium, storing a computer program thereon, wherein the program, when executed by a processor, implements the method for implementing an application based on a blockchain network according to claim 1.

21. A computer readable storage medium, storing a computer program thereon, wherein the program, when executed by a processor, implements the method for implementing an application based on a blockchain network according to claim 10.
